(19) United States
(12) Patent Application Publication
(10) Pub. No.: US 2006/0128569 A1
(43) Pub. Date: Jun. 15, 2006

(54) Microencapsulated agrochemical composition

(76) Inventor: Gordon Alastair Bell, Berkshire (GB)

Correspondence Address: SYNGENTA CROP PROTECTION , INC.;PATENT AND TRADEMARK DEPARTMENT, 410 SWING ROAD, GREENSBORO, NC, 27409, US

(21) Appl. No.: 10/525,258

(22) PCT Filed: Aug. 12, 2003
(86) PCT No.: PCT/GB03/03507

§ 371 Date: Feb. 22, 2005

(30) Foreign Application Priority Data
Aug. 22, 2002 (GB) 0219611.1

(51) Int. Cl. A01N 25/28

(52) U.S. Cl. 504/359

(57) ABSTRACT

A microencapsulated agrochemical composition comprises an aqueous dispersion of microcapsules containing (a) an agrochemical (b) a water-insoluble, bioperformance enhancing adjuvant for said agrochemical wherein said adjuvant has little or no surfactant properties and (c) a water-immiscible solvent in which both the agrochemical and adjuvant are soluble.

This invention relates to a composition and in particular to a microencapsulated agrochemical composition containing an adjuvant.

It is well known that active ingredients such as agrochemicals may be formulated such that the active composition is contained within a microcapsule shell wall. Frequently the microcapsule shell wall is designed to provide controlled release as the active composition diffuses slowly through the wall or the wall is slowly degraded. There are also applications however such as those described in WO 97/44125 in which the microcapsule provides temporary protection only and is degraded relatively rapidly as soon as the composition is put into use.

Microencapsulated compositions frequently incorporate non-biologically active surface-active polymers to assist in the suspension of the microcapsules, for example in an aqueous dispersion. Numerous surfactants and adjuvants are known which enhance the bioperformance of pharmaceuticals and agrochemicals. Care must be taken however in the use of bioperformance enhancing surfactants in microencapsulated compositions since such surfactants often locate themselves at the oil/water interface during the encapsulation process and tend to interfere with the wall-forming reaction.

According to the present invention there is provided a microencapsulated agrochemical composition comprising an aqueous dispersion of microcapsules having material encapsulated therein wherein the material encapsulated within the microcapsules comprises (a) an agrochemical (b) a water-insoluble, bioperformance-enhancing adjuvant for said agrochemical wherein said adjuvant has little or no surfactant properties and (c) a water-immiscible solvent in which both the agrochemical and adjuvant are soluble.

If the agrochemical is soluble in the adjuvant, the adjuvant may be used as both adjuvant and solvent (i.e. materials (b) and (c) may be one and the same). In general however it will be more convenient to use a separate water-immiscible solvent in which both the agrochemical and adjuvant are soluble.

The adjuvant should not interfere significantly with the microencapsulation wall-forming process and for this reason has little or no surfactant properties. Typically, the adjuvant will have a Hydrophile/Lipophile balance of 9 or less. Some of the materials that come into this category will reduce interfacial tension however they would not be effective as dispersants for oil in water emulsions. It is to be understood that the term “water-insoluble” liquid adjuvant as used herein should not be taken as indicating that the solubility of the adjuvant in water is immeasurably small but rather that there is no significant loss of the adjuvant into an aqueous phase. Typically the solubility of the adjuvant in water will be less than 0.1% by weight and preferably less than 0.01% by weight. Mixtures of liquid water-insoluble adjuvants may also be used.

Water-insoluble liquid adjuvants (oils) are normally difficult to incorporate in aqueous agrochemical formulations, particularly if the composition is a concentrate that is designed to be diluted prior to use. Water-insoluble liquid adjuvants, even when they can be utilised, therefore tend to be added as a tank mix by the farmer rather than in the more convenient form of a “built-in” concentrate. Furthermore even adjuvant compositions designed to be added as a tank mix tend to be a complex mixture having components such as surfactants whose purpose is to increase the compatibility of the primary liquid adjuvant.

Suitable water-insoluble adjuvants having little or no surfactant properties preferably have the formula
R—X (I)
and alkoxylated derivatives thereof wherein R is a branched or straight chain alkyl or akenyl group having from 12 to 20 carbon atoms and X is hydroxy, amine (primary, secondary, tertiary or quaternary), amine oxide, phosphonate, phosphate, phosphate ester, thiol, sulphoxide, sulphone, sulphonate, sulphate, heterocyclic moiety (imidazoline, morpholine, pyrrolidone, piperazine etc), glucoside, polyglucoside or alkylated gucoside, sarcosinate, betaine (including sulpho and phospho betaines), amidoamines, carboxylic acid, amide, ester and combinations of these groups such as ether sulphates, amines, carboxylates and phosphonates. The group —X may be alkoxylated provided this does not raise the HLB above 9. The alkoxy group will generally contain from 2 to 4 carbon atoms. In particular samples with an average of 1 to 2 ethoxy groups may generally be incorporated without imparting significant surfactant properties. Propoxy groups or butyloxy groups generally do not have the effect of imparting surfactant properties and it is possible therefore to introduce a greater number of such groups provided that the adjuvant remains a liquid. Typically there may be introduced form 1 to 20 such groups.

R is preferably a branched or straight chain alkyl or alkenyl group containing from 16 to 20 carbon atoms. When R is an alkenyl group it may have one or more double bonds which may be in either cis or trans configuration(s). Preferably R₁ has from 1 to 3 double bonds. It is generally preferred that the double bond(s) are in the cis configuration. It is especially preferred that R₁ is a C₁₈ branched chain alkyl or C₁₈ alkenyl group for example oleyl or isostearyl. In all the above, R may be optionally alkoxylated.

Especially preferred adjuvants are oleyl alcohol or stearyl alcohol, optionally alkoxlated with from 0 to 2 ethoxy groups; and oleic acid or stearic acid and C1 to C4 alkyl esters thereof.

As examples of adjuvants suitable for use in the composition of the present invention there may be mentioned:-
“Brij” 92, oleyl alcohol ethoxylate with an average of 2 moles of ethoxylate
“Adol” 320, oleyl alcohol
“Priolene” 6910, oleic acid
“Turbocharge”, proprietary blend of oils and short chain ethoxylates
“Merge”, proprietary blend of oils and short chain ethoxylates
“Dash”, proprietary blend of oils and short chain ethoxylates
“Silwet” L77, ethoxylated silicone
“Ethomeen” S12, Short chain ethoxylated fatty amine
“Hystrene” 9018, Stearic acid.

Those skilled in the art will be able to select the adjuvant class that is most suitable for a given active ingredient. For example adjuvants particularly suitable for enhancing the bioperformance of lipophilic agrochemicals include the commercial blends “Turbocharge”, “Dash”, LI 700 and “Merge” and single component adjuvants such as methyl oleate, oleyl alcohol and “Brij” 92.

Also suitable are novel adjuvants disclosed in our co-pending International application WO 03/022048A1. Thus suitable adjuvants may have the formula
R₁—(CO)ₘ—O—[—R₂O—]ₙ—R₃ (II)
wherein R₁ is a C₁₆ to C₂₀ straight or branched chain alkyl or alkenyl group, R₂ is ethyl or isopropyl, n is from 8 to 30 and m is 0 or 1 and when R₂ is ethyl, R₃ is a C₁ to C₇ alkyl group and when R₂ is isopropyl, R₃ is hydrogen or a C₁ to C₇ alkyl group.

The process of the present invention is particularly suitable for lipohilic agrochemicals which dissolve most readily in the oil phase.

Examples of suitable lipophilic agrochemicals include:
(a) herbicides such as fluzifop, mesotrione, fomesafen, tralkoxydim, napropamide, amitraz, propanil, cyprodanil, pyrimethanil, dicloran, tecnazene, toclofos methyl, flamprop M, 2,4-D, MCPA, mecoprop, clodinafop-propargyl, cyhalofop-butyl, diclofop methyl, haloxyfop, quizalofop-P, indol-3-ylacetic acid, 1-naphthylacetic acid, isoxaben, tebutam, chlorthal dimethyl, benomyl, benfuresate, dicamba, dichlobenil, benazolin, triazoxide, fluazuron, teflubenzuron, phenmedipham, acetochlor, alachlor, metolachlor, pretilachlor, thenylchlor, alloxydim, butroxydim, clethodim, cyclodim, sethoxydim, tepraloxydim, pendimethalin, dinoterb, bifenox, oxyfluorfen, acifluorfen, fluoroglycofen-ethyl, bromoxynil, ioxynil, imazamethabenz-methyl, imazapyr, imazaquin, imazethapyr, imazapic, imazamox, flumioxazin, flumiclorac-pentyl, picloram, amodosulfuron, chlorsulfuron, nicosulfuiron, rimsulfuron, triasulfuron, triallate, pebulate, prosulfocarb, molinate, atrazine, simazine, cyanazine, ametryn, prometryn, terbuthylazine, terbutryn, sulcotrione, isoproturon, linuron, fenuron, chlorotoluron and metoxuron;
(b) fungicides such as azoxystrobin, trifloxystrobin, kresoxim methyl, famoxadone, metominostrobin and picoxystrobin, carbendazim, thiabendazole, dimethomorph, vinclozolin, iprodione, dithiocarbamate, imazalil, prochloraz, fluquinconazole, epoxiconazole, flutriafol, azaconazole, bitertanol, bromuconazole, cyproconazole, difenoconazole, hexaconazole, paclobutrazole, propiconazole, tebuconazole, triadimefon, trtiticonazole, fenpropimorph, tridemorph, fenpropidin, mancozeb, metiram, chlorothalonil, thiram, ziram, captafol, captan, folpet, fluazinam, flutolanil, carboxin, metalaxyl, bupirimate, ethirimol, dimoxystrobin, fluoxastrobin, orysastrobin, metominostrobin, prothioconazole, 8-(2,6-diethyl-4-methyl-phenyl)tetrahydropyrazolo[1,2-d][1,4,5]oxadiazepine-7,9-dione and 2,2,-dimethyl-propionic acid-8-(2,6-diethyl-4-methyl-phenyl)-9-oxo-1,2,4,5-tetrahydro-9H-pyrazolo[1,2-d][1,4,5]oxadiazepine-7-yl ester; and
(c) insecticides such as abamectin, acephate, acetamiprid, acrinathrin, alanycarb, aldicarb, allethrin, alpha-cypermethrin, amitraz, asulam, azadirachtin, azamethiphos, azinphos-ethyl, azinphos-methyl, bendiocarb, benfuracarb, bensultap, beta-cyfluthrin, beta-cypermethrin, bifenthrin, bioallethrin, bioresmethrin, bistrifluron, borax, buprofezin, butoxycarboxim, cadusafos, carbaryl, carbofuran, chlorpropham, clothianidin, cyfluthrin, cyhalothrin, cyprmethrin, deltamethrin, diethofencarb, diflubenzuron, dinotefuran, emamectin, endosulfan, fenoxycarb, fenthion, fenvalerate, fipronil, halfenprox, heptachlor, hydramethylnon, imidacloprid, imiprothrin, isoprocarb, lambda cyhalothrin, methamidophos, methiocarb, methomyl, nitenpyram, omethoate, permethrin, pirimicarb, pirimiphos methyl, propoxur, tebufenozide, thiamethoxam, thiodicarb, triflumoron, and xylylcarb.

The proportion of adjuvant relative to active ingredient can readily be selected by one skilled in the art as most suitable for the active ingredient concerned to meet the intended utility. It is an advantage of the compositions of the present invention however that the concentration of the adjuvant is not limited by compatibility or stability problems provided a suitable solvent is selected in which both the adjuvant and agrochemical both have the desired solubility. In contrast adjuvants for use in the present invention are difficult or impossible to “built-in” to conventional aqueous formulations of the agrochemical. The proportion of adjuvant to active ingredient can thus mirror that found to be most useful in tank-mix application even if this content of adjuvant would be unstable when “built-in” using conventional techniques. Typically the ratio of adjuvant to active ingredient will range from 1:50 and 200:1 and preferably from 1:5 to 20:1 A wide variety of materials suitable for use as the water-immiscible solvent will occur to those skilled in the art. Examples include diesel oil, isoparaffin, aromatic solvents, particularly alkyl substituted benzenes such as xylene or propyl benzene fractions, and mixed naphthalene and alkyl naphthalene fractions; mineral oils, white oil, castor oil, sunflower oil, kerosene, dialkyl amides of fatty acids, particularly the dimethyl amides of fatty acids such as caprylic acid; chlorinated aliphatic and aromatic hydrocarbons such as 1,1,1-trichloroethane and chlorobenzene, esters of glycol derivatives, such as the acetate of the n-butyl, ethyl, or methyl ether of diethylene glycol, the acetate of the methyl ether of dipropylene glycol, ketones such as methylethylketone, isophorone and methyl or trimethylcyclohexanone (dihydroisophorone) and esters such as hexyl or heptyl acetate, methyl oleate or octyl methyl cinnamate. Mixtures of water-immiscible solvents may be used.

It will be appreciated that not all water-immiscible solvents will necessarily be suitable for every combination of adjuvant and agrochemical but those skilled in the art will readily be able to select the most appropriate water-immiscible solvent. Simple fatty alcohols such as oleyl alcohol can be encapsulated without the use of a solvent although solvents such as ketones, for example methylethylketone or cyclohexanone or mixtures thereof may conveniently be used. A non-polar solvent such as SOLVESSO 200 can be used with adjuvants that have relatively few ethoxylate groups, whereas a more polar solvent such as a ketone is appropriate in the case of a longer chain ethoxylate such as “Silwet” L77.

The composition may be microencapsulated using techniques well known in the art.

The encapsulation step is carried out by forming a polymer wall around the oil droplets containing the agrochemical and adjuvant. Preferably the polymer wall is formed by the reaction of two or more polymer precursors. Many such polymer precursors are known and suitable polymer precursors and reaction conditions can be selected by one skilled in the art to provide a polymer wall thickness and durability ranging from relatively transient polymer walls which can readily be disrupted to relatively durable polymer walls which provide slow release over a considerable period of time. Polymer precursors are also known which provide a polymer wall material that is degraded by external factors. Thus for example once an agrochemical formulation is diluted into water for application onto a target crop, the polymer wall material may be disrupted by the change in osmotic pressure within the encapsulated droplets or for example may be degraded under the action of sunlight.

A further example is the incorporation into the wall of groups that can be chemically cleaved by appropriate reagents. The incorporation of such base cleavable groups into aminoplast walls is described in WO 00/05951.

Polymer precursors generally comprise two or more components that react together to form a crosslinked polymer wall. A wide range of polymer precursors is known for use in encapsulation. Polyisocyanates which can be reacted with polyamines, with polyols or with polythiols. Polyfunctional acid chlorides which can be reacted with polyols or polyamides. Aminoplast resins, such as melamine formaldehydes and phenol formaldehydes which can be reacted with polyols or polythiols.

Depending on the solubility of the wall forming components in the oil and in water, one component can be dissolved in the oil and the other component can be dissolved in the water so that reaction between the two to form the capsule wall occurs at the interface between the two.

Alternatively, in the case where reaction between the components is relatively slow in the absence of catalyst, the components can be dissolved together in the oil before making the initial dispersion, and a water-soluble phase transfer catalyst can be added to the water to cause reaction between them to form the capsule wall at the oil droplet surface.

This type of process is illustrated by aminoplasts which can be reacted with a crosslinker such a polythiol as described for example in U.S. Pat. No. 4,956,129 and U.S. Pat. No. 5,332,584. The reaction between the two components is slow in the absence of catalyst and both components can be dissolved in the oil together. The wall-forming reaction can be initiated by adding a water-soluble phase transfer catalyst to the water. For example, an aminoplast resin, such as Beetle 80 (an etherified urea formaldehyde, trade mark of American Cyanamid) can be dissolved in the oil, together with a crosslinker, for example a polythiol such as pentaerythritol tetrakis (3-mercaptopropionate) and then a phase transfer catalyst such as an alkylnaphthalene sodium sulphonate can be added to the emulsion to cause a polymer wall to form at the oil/water interface so encapsulating the oil phase droplets.

A further type of process for by which aminoplast walls can be formed is described in WO 01/19509.

Coacervate chemistries can also be employed to good effect for these formulations. Many techniques of producing a coacervate are known. Such techniques include gelatin/gum arabic systems and the synthetic pairing effects of polymeric anionic/cationic systems.

The process described in EP 0902724 is particularly suitable for providing rapid release of the adjuvant component.

The composition of the present invention is conveniently prepared by dissolving the agrochemical and adjuvant in the solvent together with oil-soluble components used to form the microcapsule wall and thereafter forming an oil-in-water emulsion, optionally in the presence of a stabiliser such as a water-soluble polymer for example polyvinyl alcohol. A suitable microencapsulation reaction is then used to form the microcapsules. Suspending or dispersion aids may be used to suspend the microcapsules. It has been found that the type of dispersant used in the final mixture is not critical in determining the storage stability and quality of the formulation. Thus it is perfectly possible to include dispersants as suspending or dispersion aids at this stage which would interfere with the encapsulation process. Conventional additives for agrochemical formulations may also be included in the composition.

If it is desired to permit fast release of the encapsulated composition during drying of the formulation on a leaf, or similar, surface it is necessary to have thin walled microcapsules. Typically microcapsules with a mean diameter of about 2 microns require a polymer wall concentration in the formulation of about 3% by weight. Greater quantities of polymer will slow the release rate. The diameter of the capsules and the quantity of wall forming polymer can be used to tune the performance of the capsules, depending on the required pesticide and the conditions of use.

The invention is illustrated by the following Examples in which all parts and percentages are by weight unless otherwise stated.

### EXAMPLE 1

Tralkoxydim technical powder (96.8% w/w active component) was weighed into a beaker (0.56 g) along with the solvent methyl cyclohexanone (2.3 g). This dissolved with gentle stirring at which point oleyl alcohol (1.15 g) was added. Diphenylmethane-4,4′-diiscyanate (MDI, Suprasec 2211, Huntsman Corporation) was added (0. 12 g) to create a solution that was used as the oil phase in the subsequent microencapsulation process. The oil phase was added slowly and with vigorous stirring using a high shear mixer to 3.39 g of 20 % w/w aqueous polyvinyl alcohol solution (Gohsenol GLO3, Nippon Synthetic Chemical Industry Company). When the oil phase was added the emulsion was sheared vigorously for two minutes then 0.4 g of a 10% diethylene triamine (DETA) solution was added rapidly. The resulting microcapsule suspension was diluted with 2 g of water and had the following percentage concentrations.

| | |
|---|---|
| Tralkoxydim | 5.6 |
| methyl cyclohexanone | 22.9 |
| Oleyl alcohol | 11.5 |
| MDI | 1.2 |
| GLO3 (20%) | 6.8 |
| DETA 10% | 0.4 |
| Water | 51.7 |

### EXAMPLES 2-17

Compositions of the invention were prepared using the general method of Example 1. The active ingredient, adjuvant and solvent and proportions of wall-forming materials and other ingredients are shown in Table 1

| Example | | | |
|---|---|---|---|
| Number | Agrochemical | Adjuvant | Solvent |
| 2 | Azoxystrobin | “Brij” 92 | Methylcyclohexanone |
| 3 | Azoxystrobin | Oleyl alcohol | Methylcyclohexanone |
| 4 | Azoxystrobin | Crop oil | Methylcyclohexanone |
| | | Concentrate based | |
| | | on “Brij” 92 | |
| 5 | Chlorothalonil | “Turbocharge” | Aromatic 100 |
| 6 | Diuron | “Turbocharge” | Methylcyclohexanone |
| 7 | Fomesafen | “Turbocharge” | Methylcyclohexanone |
| 8 | Fomesafen | “Silwet” L77 | Methylethyl ketone |
| 9 | Fomesafen | Oleyl alcohol | Methylethyl ketone |
| 10 | Fomesafen | “Brij” 92 | Methylethyl ketone |
| 11 | Fomesafen | “Silwet” L77 | MEK/Me |
| | | | cyclohexanone* |
| 12 | Fomesafen | Oleyl alcohol | Methyl cyclohexanone |
| 13 | Fomesafen | “Brij” 92 | MEK/Me cyclohexanone |
| 14 | Tralkoxydim | “Brij” 92 | Methylcyclohexanone |
| 15 | Tralkoxydim | Oleyl alcohol | Methylcyclohexanone |
| 16 | Tralkoxydim | Turbocharge | Methylcyclohexanone |
| 17 | Picoxystrobin | Crop oil | Methylcyclohexanone |
| | | Concentrate based | |
| | | on “Brij” 92 | |

*MEK/Me cyclohexanone indicates a mixture of methyl ethyl ketone and methyl hexanone.

| Example No | Agrochemical % | Adjuvant | Solvent | MDI | GLO3 | DETA | Water |
|---|---|---|---|---|---|---|---|
| 2 | 5% | 10% | 25% | 2.8% | 8% | 0.7% | 48.5% |
| 3 | 5% | 10% | 26% | 2.9% | 8% | 0.7% | 48.4% |
| 4 | 5% | 10% | 25% | 2.7% | 8% | 0.7% | 48.6% |
| 5 | 2% | 2% | 36% | 1.2% | 7% | 0.4% | 51.4% |
| 6 | 2% | 2% | 36% | 1.2% | 7% | 0.4% | 51.4% |
| 7 | 4% | 4% | 32% | 1.2% | 7% | 0.4% | 51.4% |
| 8 | 3% | 3% | 28% | 6% | 4% | 0.3% | 55.7% |
| 9 | 3% | 3% | 28% | 6% | 4% | 0.3% | 55.7% |
| 10 | 3% | 3% | 28% | 6% | 4% | 0.3% | 55.7% |
| 11 | 3% | 3% | 26% | 10% | 4% | 0.6% | 53.4% |
| 12 | 3% | 3% | 26% | 10% | 4% | 0.6% | 53.4% |
| 13 | 3% | 3% | 26% | 10% | 4% | 0.6% | 53.4% |
| 14 | 5% | 10% | 25% | 1.2% | 7% | 0.4% | 51.4% |
| 15 | 6% | 11% | 23% | 1.2% | 7% | 0.4% | 51.4% |
| 16 | 6% | 12% | 24% | 2.5% | 8% | 1.7% | 45.8% |
| 17 | 8% | 8% | 24% | 1.2% | 7% | 0.4% | 51.4% |

### Comparisons 1-5

These comparisons illustrate that microencapsulated compositions of the present invention provide stable concentrates in which the adjuvant is present in the microcapsule at concentrations that would not be stable using conventional techniques.

### Comparison 1

As a comparison to Example 3 a sample was prepared which contained oleyl alcohol in water at the same concentration as the microencapsulated sample (10% w/w). This sample formed two clear layers. The addition of solvent and a typical emulsifier led to the formation of emulsions that were stable for short time periods however these separated after one hour and they were not found to be stable with a commercial suspension concentrate of azoxystrobin.

### Comparison 2

As a comparison to Example 2 a sample was prepared which contained “Brij” 92 in water at the same concentration as the microencapsulated sample (10% w/w). This sample flocculated and was unusable, even where the solvent and/or a typical emulsifier were added.

A non-encapsulated formulation corresponding to that shown in Example 2 was not found to be stable.

### Comparison 3

As a comparison to Example 4 a sample was prepared which contained the commercial tank mix adjuvant Turbocharge in water at the same concentration as the microencapsulated sample (10% w/w). This sample creamed after a period of one hour. An attempt was made to resolve this problem using the solvent and/or a typical emulsifier however long term stability was not achieved indicating that the formulation task was not straightforward. A non-encapsulated formulation corresponding to that shown in Example 4 was not found to be stable.

### Comparison 4

As a comparison to Example 9 a sample was prepared which contained oleyl alcohol in water at the same concentration as the microencapsulated sample (3% w/w). This sample formed two distinct clear layers however it was possible to form an emulsion of the oil in water by the addition of Synperonic NP8. This emulsion was not stable over periods of one hour or longer. The addition of the solvent and/or the pesticide (fomesafen) did not help with the long term stability problem.

### Comparison 5

As a comparison to Example 10 a sample was prepared which contained Brij 92 in water at the same concentration as the microencapsulated sample (3% w/w). This sample flocculated and was unusable, even where the solvent and/or a typical emulsifier was added. A non-encapsulated formulation corresponding to that shown in Example 10 was not stable over a period of one hour.

1. A microencapsulated agrochemical composition comprising an aqueous dispersion of microcapsules having material encapsulated therein wherein the material encapsulated within the microcapsules comprises (a) an agrochemical (b) a water-insoluble, bioperformance-enhancing adjuvant for said agrochemical wherein said adjuvant has little or no surfactant properties and (c) a water-immiscible solvent in which both the agrochemical and adjuvant are soluble.

2. A composition according to claim 1 wherein the adjuvant has a Hydrophile/Lipophile balance of 9 or less.

3. A composition according to claim 1, wherein the adjuvant has the formula
R—X (I)
and alkoxylated derivatives thereof wherein R is a branched or straight chain alkyl or akenyl group having from 12 to 20 carbon atoms and X is hydroxy; primary, secondary, tertiary or quaternary amine; amine oxide; phosphonate; phosphate; phosphate ester; thiol; sulphoxide; sulphone; sulphonate; sulphate; a heterocyclic moiety; glucoside; polyglucoside or alkylated glucoside; sarcosinate; betaine; amidoamine; carboxylic acid; amide; ester; ether sulphate; ether amine; ether carboxylate; and ether phosphonate.

4. A composition according to claim 3, wherein the group —X is alkoxylated provided the HLB of the adjuvant is not greater than 9.

5. A composition according to claim 4, wherein the alkoxy group contains from 2 to 4 carbon atoms.

6. A composition according to claim 3, having an average of 1 to 2 ethoxy groups per adjuvant molelcule or from 1 to 20 propoxy or butyloxy grops per adjuvant molecule.

7. A composition according to claim 3, wherein R is an optionally alkoxylated branched or straight chain alkyl or alkenyl group containing from 16 to 20 carbon atoms.

8. A composition according to claim 7, wherein R is an optionally alkoxylated C₁₈ branched chain alkyl or C₁₈ alkenyl group.

9. A composition according to claim 8, wherein R is optionally alkoxylated oleyl or isostearyl.

10. A composition according to claim 1, wherein the ratio of adjuvant to the agrochemical is from 1:50 to 200:1.

11. A composition according to claim 1, wherein the agrochemical is a lipophilic agrochemical.

12. A composition according to claim 1, wherein the water-immiscible solvent is diesel oil; isoparaffin; xylene; a propyl benzene fraction; a mixed naphthalene and alkyl naphthalene fraction; a mineral oil; white oil; castor oil; sunflower oil; kerosene; a dimethyl amide of caprylic acid; a chlorinated aliphatic or aromatic hydrocarbon; the acetate of the n-butyl, ethyl, or methyl ether of diethylene glycol; the acetate of the methyl ether of dipropylene glycol; methylethylketone; isophorone; methyl or trimethylcyclohexanone (dihydroisophorone); hexyl or heptyl acetate; methyl oleate; octyl methyl cinnamate and mixtures of two or more thereof.

13. A composition according to claim 1, wherein the adjuvant has the formula (II)
R₁—(CO)ₘ—O—[—R₂O—]ₙ—R₃ (I)
wherein R₁ is a C₁₆ to C₂₀ straight or branched chain alkyl or alkenyl group, R₂ is ethyl or isopropyl, n is from 8 to 30 and m is 0 or 1 and when R₂ is ethyl, R₃ is a C₁ to C₇ alkyl group and when R₂ is isopropyl, R₃ is hydrogen or a C₁ to C₇ alkyl group.
